(19) United States
(12) Patent Application Publication
(10) Pub. No.: US 2020/0408411 A1
(43) Pub. Date: Dec. 31, 2020

(54) INTERACTION MODULE

(71) Applicant: BSH Hausgeräte GmbH, Munich (DE)

(72) Inventors: Markus Helminger, Bergen (DE); Gerald Horst, Karlsruhe (DE); Philipp Kleinlein, München (DE)

(21) Appl. No.: 16/975,738

(22) PCT Filed: Feb. 25, 2019
(86) PCT No.: PCT/EP2019/054526

§ 371 Date: Aug. 26, 2020

(30) Foreign Application Priority Data
Mar. 7, 2018 (DE) 10 2018 203 349.8

(51) Int. Cl. F24C 3/12; F27D 21/02; G06F 3/042

(52) U.S. Cl. CPC F24C 3/12; F27D 2021/026; G06F 3/0425; F27D 21/02

(57) ABSTRACT

An interaction module includes a projector configured to project a first image onto a working surface; and a camera configured to record a second image of an object that is placed on the working surface.

The invention relates to an interaction module. In particular the invention relates to an interaction module for dynamically displaying information on a working surface.

An interaction module comprises a projector, which is designed to project an image onto a working surface, and an optical scanning device for determining a gesture. The projector can be used for example to project a control element onto the working surface and the scanning device determines when a user touches the control surface with their finger. This can trigger a predetermined action, for example switching an appliance in the region of the working surface on or off. The interaction module can be used in particular in the region of a working surface in a kitchen and the control function can relate to a kitchen appliance, for example a cooker, oven or extractor.

One object of the present invention is to provide an improved interaction module. The invention achieves this object by means of the subject matter of the independent claims. Preferred embodiments are set out in subclaims.

According to a first aspect of the present invention an interaction module comprises a projector, which is designed to project a first image onto a working surface; and a camera, which is designed to record a second image of an object placed on the working surface.

The working surface generally has a horizontal surface and the interaction module can be attached above this surface. The camera allows the interaction module to be used to supply the second image. The function of the projector can expediently assist that of the camera here. For example the camera can illuminate the object while the camera records the second image. Particularly when the interaction module is used in the region of a kitchen, food being prepared there can be photographed immediately and with little outlay.

The projector can also be designed to project a position marker onto the working surface, the position marker indicating a scan region of the camera. For example the position marker can project a point, a spot or a symbol, on which the object can preferably be centrally positioned. There is then no need for a viewfinder or similar output apparatus. The user can position the object simply and precisely in a scan region of the camera. By displaying the position marker at a predetermined point it is possible to produce second images of different objects from the same perspectives, so that the images can be compared more easily.

The position marker can indicate a delimitation of the scan region of the camera in the plane of the working surface. For example the position marker can run along a contour of the region that can be imaged using the camera. The contour can also run inside or outside the region that can be imaged. This allows the user to compose the image to be produced more easily, for example by moving an additional object, such as a spice, flatware or an ingredient partially or completely into the scan region.

It is further preferable for optical axes of the camera and projector to be close to one another, so that the position marker is visible on part of the object, if the object is not completely within the scan region. The camera and projector here are preferably attached above the working surface, so that the object is located between the interaction module and the working surface. If the projector is now used to illuminate the region that can be recorded by the camera as a contour or in its entirety, a light beam or light pyramid is effectively supplied, which at least partially illuminates the generally three-dimensional object. A user is immediately aware if a segment of the object projects out of this three-dimensional light body. In different embodiments the position marker can be within the region that can be imaged by the camera, with an unilluminated outward projecting segment of the object not visible on the later, second image. Alternatively the position marker can illuminate a region outside the region that can be imaged, in which case an outward projecting segment of the object that is illuminated is not shown on the later, second image. Any combinations of these embodiments are also possible.

The optical axes of the camera and projector can be considered close when they are at a distance of less than 20 cm, more preferably less than 15 cm, even more preferably less than approx. 10 cm from one another. These distances are based on standard proportions of a kitchen working surface, which can have a depth of approx. 60 to 65 cm and a clear height (for example up to a top cupboard or extractor hood) of approx. 45 to 80 cm. The closer the optical axes are to one another, the smaller the parallax error can be. In other words by bringing the optical axes closer to one another, it is possible to reduce any imaging error between the projector and camera.

The interaction module can additionally comprise an optical scanning device, which is designed to determine a gesture of a user in a region above the working surface. In particular the interaction module can be designed to control a household appliance, more preferably a kitchen appliance. The interaction module can additionally be used to control the camera. For example a control surface for triggering the camera with a time delay can be displayed and the second image can be brought about a predetermined time after the determination of user contact with the button. This makes camera operation easy and hygienic, even if the user does not have clean hands for example. Of course the optical scanning device can also be designed to detect contact with the button by another object, for example a cooking spoon or other equipment.

In a further embodiment the first image projected by the projector comprises a representation of the second image. This allows precise control of the recorded, second image. It allows a user to change the composition of the second image as desired particularly easily.

It is advantageous here if the second image is displayed outside a scan region of the camera. The scan region of the camera is smaller here than a region on the working surface that can be projected by the projector. This avoids the image in image problem, where the second image projected onto the working surface is recorded again by the camera and projected anew, which can result in infinite image in image representation, in particular if the image content is changed. The projector particularly preferably also projects control surfaces or buttons outside the scan region of the camera. They are monitored using an optical scanning device for capturing user gestures. The scanning device here is arranged in the interaction module. A user finger approaching a button and captured by the scanning device triggers corresponding control commands. Such control commands can be the recording or storing of a camera image or an optical change to the image background or illumination of the object by the projector. The projected buttons can be configured for example as virtual pressure switches or rotary or slide actuators. The virtual buttons here are preferably arranged close to the representation of the second image.

In a further embodiment the projector is designed to illuminate the object with light of a predetermined spectrum. The spectrum comprises different wavelength ranges of visible light, which can be represented with different intensities. This allows for example cold light, warm light or colored light to be supplied. In particular a spectrum appropriate for food photography can be used to produce a realistic or pleasing second image of a dish.

The projector can also be designed to illuminate different segments of the object with different predetermined spectra. For example if the object comprises a plate of meat and salad, the meat can be illuminated with reddish to brownish light tones, while the salad can be highlighted more effectively with greenish to yellowish light tones. The user can therefore see more clearly, before the second image is recorded, which colors will be visible on the image afterwards.

The projector can also be designed to project a predetermined background around the object. The background can be a color, structure or pattern. Additional objects can also be projected onto the working surface, for example cutlery or a floral decoration.

The interaction module can also have an interface for receiving a background to be projected. One or more backgrounds can be stored in a data storage unit. This helps a user to select their preferred backgrounds or for example to consistently use a particular background with a watermark or personal logo. The user can optionally select the background to be projected from a number of backgrounds stored in the data storage unit.

The interaction module can comprise a data storage unit, which is designed to hold a recipe. The interaction module can also comprise a processing facility, which is designed to assign the second image to a recipe in the data storage unit. This allows the user to store the second image of a successfully or less successfully completed recipe for later use. The image can be used as a reminder or for the long-term optimization of the recipe.

In a further embodiment the interaction module also comprises an interface for supplying the second image, for example to a social network. This allows users to share the results of their efforts more widely in a social group. They are thus able to improve their learning or teaching regarding the preparation of a dish.

According to a second aspect of the invention a method for using an interaction module described herein comprises steps of projecting a first image onto a working surface using the projector; and recording a second image of an object placed on the working surface using the camera.

The method can be performed in particular wholly or partially using a processing facility, which can be part of the interaction module. To this end part of the method can be present in the form of a computer program product with program code means, in order to perform the corresponding part of the method when the part is running on a processing facility. The computer program product can also be stored on a computer-readable data medium. Features or advantages of the method can be applied to the apparatus and vice versa.

The invention is described in more detail below with reference to the accompanying figures, in which:

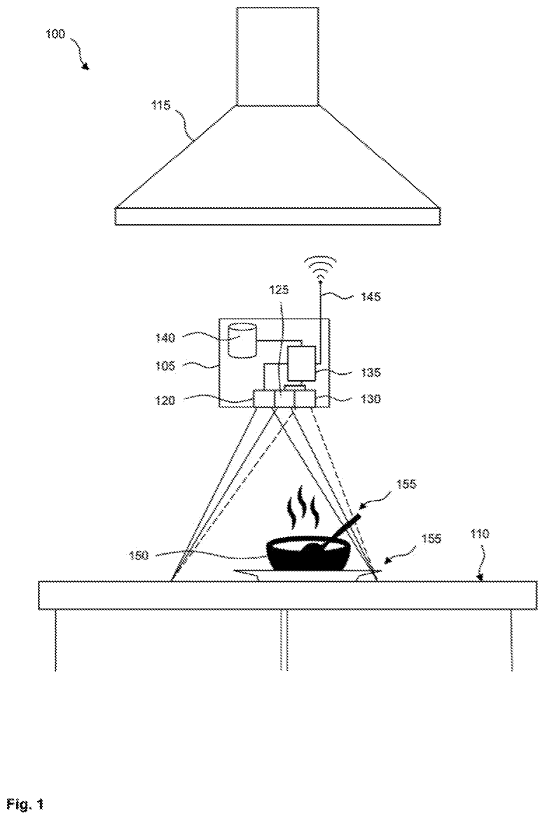

FIG. 1 shows an exemplary system with an interaction module; and

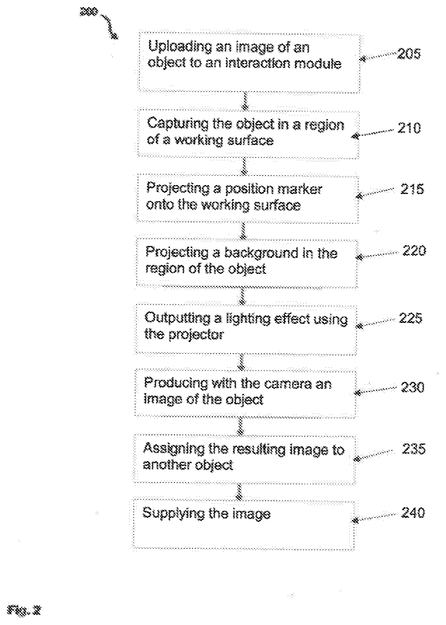

FIG. 2 shows a flow diagram of an exemplary method.

FIG. 1 shows an exemplary system 100 with an interaction module 105. The interaction module 105 is attached in the region of a working surface 110, it being possible to for the working surface 110 to comprise in particular a table top or worktop, in a horizontal direction in particular. The interaction module 105 is preferably attached at a distance of at least approx. 35 cm above the working surface 110. The interaction module 105 here can in particular be attached to an underside of a unit or appliance, which is fixed in a region above the working surface 110. A distance between the interaction module 105 and a bearing surface in a depthwise direction, in particular a wall, can be for example approx. 20 cm. The unit or appliance can be fastened to the bearing surface. The interaction module 105 can be designed to control an appliance, in particular a household appliance, as a function of a user's gesture. The interaction module 105 can be provided in particular for use in a kitchen and an exemplary appliance to be controlled can comprise for example an extractor hood 115.

The interaction module 105 comprises a projector 120, a camera 125, an optional scanning device 130 and generally a processing facility 135. A data storage unit 140 and/or an interface 145 for wireless data transfer in particular can optionally also be provided.

The projector 120, camera 125 and scanning device 130 are substantially directed onto corresponding regions of the working surface 110. For example the projector 120 can be used to project a button onto the working surface 110. A user can touch the button with their finger for example and this can be captured by the scanning device 130 and converted to a corresponding control signal. An appliance, for example the extractor hood 115, can in particular be controlled in this manner. The projector 120 is generally designed to display any content, even moving images.

It is proposed that the interaction module 105 is also equipped with the camera 125, to produce an image of an object 150 arranged on the working surface 110. In the diagram in FIG. 1 the object 150 is for example a prepared dish, which is shown by way of example in a bowl on a plate with a spoon. The dish can have been prepared by a user, for example with the aid of technical facilities in the kitchen shown, in particular the interaction module 105. Before serving the user can produce an in particular electronic image of their work and optionally store it in the data storage unit 140 or send it out by means of the interface 145, for example to a service, in particular in a Cloud, or a social network.

It is further proposed that production of the image is assisted by the projector 120. To this end for example a position marker can be projected onto the working surface 110 to give the user an idea of which surface can be imaged by the camera 125 on the working surface 110. The position marker can be for example a spot, crosshair, point, Siemens star or other figure, on which the object 150 can be centered. The position marker can also show a delimitation of the region that can be imaged. For example the entire region of the working surface 110 that can be imaged by the camera 125 can also be illuminated using the projector 120. The projector 120 and camera 125 are preferably brought as close as possible to one another within the interaction module 105 so that it can accurately be assumed that only the segments of the object 150 illuminated by the projector 120 will appear on the image. In another variant the position marker can be outside the region that can be imaged by the camera 125 so that the segments of the object 150 which will lie outside the image detail can specifically be illuminated. In the diagram in FIG. 1 two segments 155 by way of example lie outside the region that can be imaged. A user can see this from the illumination and decide whether or not they are happy with such cropping.

In further embodiments the projector 120 can illuminate the object 150 or add a projected image or pattern, which extends on the object 150 itself or the working surface 110, while the image is being recorded. For example a pattern reminiscent of a tablecloth for example can be projected in a region away from the object. An additional object can also be projected into the region of the image by projection. The projector 120 can also be used to illuminate the object 150, it being possible in particular to tailor a light intensity and/or light temperature to the object 150 to be recorded or user requirements. In certain circumstances a segment, partial object or detail of the object 150 can be removed from the image or made inconspicuous by projection.

The camera 125 can be triggered by a user performing a corresponding gesture within a scan region of the scanning device 130. The scan region can in particular correspond as closely as possible to, ideally coincide with, the recording region of the camera 125 or the projection region of the projector 120. A button can be superimposed on the image projected by the projector 120, it being possible for the user to touch said button manually or tactilely to control the production of an image. The camera 125 is preferably triggered with a time delay to give the user time to remove their hand from the recording region of the camera 125 and the projector 120 time to cancel the displayed button.

In a further embodiment the first image projected by the projector 120 comprises a representation of the second image, the representation of the second image being arranged outside a scan region of the camera 125. Virtual buttons or operating elements are arranged immediately adjacent to the representation or projection of the second image, allowing the user to trigger the camera 125 to record or store the second image and to change the image background. Operation of the virtual operating elements by the user is recognized by evaluating the user's gestures captured by the scanning device 130.

A resulting image can be stored in the data storage unit 140. It can also be assigned to a recipe, for example, which can also be stored in the data storage unit 140. The image can also be sent out using the interface 145, optionally for example to a portable mobile computer (smartphone, laptop), a storage or processing service or a social network.

FIG. 2 shows a flow diagram of an exemplary method 200. The method 200 can be performed in particular using the interaction module 105 and more preferably using the processing facility 135.

In an optional step 205 a background, a pattern, the image of an object 150 or other image information can be uploaded to the interaction module 105. One or more predetermined and/or user-defined backgrounds can later be selected for projection from a collection.

In an optional step 210 the object 150 in the region of the working surface 110 can be captured. Capturing can be performed using the camera 125, the scanning device 130 or by a user specification. In one embodiment specification can take place by user gesture control, for which purpose the projector 120 projects a control surface onto the working surface 110, which the user touches, the contact being captured by means of the scanning device 130.

In a step 215 a position marker can be projected onto the working surface 110, to make it easier for the user to position the object 150 within an imaging region of the camera 125. An instruction can also be projected for further user guidance for example. One or more buttons can also be projected for further control of the method 200.

In a further embodiment a marker can also be projected onto the object 155, comprising a proposed garnish or division. This can be used in particular for a round object such as a cake, pizza or fruit. For example a pattern can be projected onto a cake, making it easier for the user to divide it into a predetermined number of equal pieces. The number of pieces can be predetermined or selected in particular in dialog form. This allows an otherwise difficult division into an uneven number or a prime number also to be performed.

In a step 220 a background can be projected in the region of the object 150. The background can have been uploaded, otherwise predetermined or dynamically generated beforehand in step 205.

In a step 225 a lighting effect can be output using the projector 120. The lighting effect can be adjusted in particular in respect of brightness, color spectrum, light temperature or tone. The lighting effect can influence the outputting of the background for example. In a step 230 the camera 125 can produce an image of the object 150. In this process the object 150 and/or a surrounding region of the working surface 110 can preferably be illuminated using the projector 120.

In an optional step 235 the resulting image can be assigned to another object. In particular the image can be assigned to a recipe, another image or further information, which can be held in particular in the data storage unit 140.

In a step 240 the image can be supplied, in particular using the interface 145. This can comprise saving or sending the image, for example to a social network. Before sending the user can be given the opportunity to confirm sending, to amend the image, to add text or carry out other standard editing operations.

### REFERENCE CHARACTERS

100 System
105 Interaction module
110 Working surface
115 Extractor hood
120 Projector
125 Camera
130 Scanning device
135 Processing facility
140 Data storage unit
145 Interface
150 Object
155 Segment
200 Method
205 Upload background
210 Capture object
215 Project position marker
220 Project background
225 Project lighting effect
230 Record image
235 Assign image
240 Supply image

1-14. (canceled)

15. An interaction module, comprising:
a projector configured to project a first image onto a working surface; and
a camera configured to record a second image of an object placed on the working surface.

16. The interaction module of claim 15, wherein the projector is configured to project onto the working surface a position marker which indicates a scan region of the camera.

17. The interaction module of claim 16, wherein the position marker indicates a delimitation of the scan region of the camera in a plane of the working surface.

18. The interaction module of claim 17, wherein the camera defines an optical axis and the projector defines an optical axis, with the optical axes of the camera and projector being close to one another, so that the position marker is visible on part of the object, when the object is not completely within the scan region.

19. The interaction module of claim 15, further comprising an optical scanning device configured to determine a gesture of a user in a region above the working surface.

20. The interaction module of claim 15, wherein the first image projected by the projector comprises a representation of the second image.

21. The interaction module of claim 20, wherein the representation of the second image is arranged outside a scan region of the camera.

22. The interaction module of claim 15, wherein the projector is configured to illuminate the object with light of a predetermined spectrum.

23. The interaction module of claim 22, wherein the projector is configured to illuminate different segments of the object with different predetermined spectra.

24. The interaction module of claim 15, wherein the projector is configured to project a predetermined background around the object.

25. The interaction module of claim 24, further comprising an interface for receiving the predetermined background to be projected.

26. The interaction module of claim 15, further comprising:
a data storage unit configured to hold a recipe; and
a processing facility configured to assign the second image to a recipe in the data storage unit.

27. The interaction module of claim 15, further comprising an interface for supplying the second image to a social network.

28. A method for using an interaction module, said method comprising:
projecting a first image onto a working surface using a projector; and
recording a second image of an object placed on the working surface using a camera.

29. The method of claim 28, wherein the projector projects onto the working surface a position marker which indicates a scan region of the camera.

30. The method of claim 29, wherein the position marker indicates a delimitation of the scan region of the camera in a plane of the working surface.

31. The method of claim 30, further comprising configuring the camera and projector such that their optical axes are close to one another, so that the position marker is visible on part of the object, when the object is not completely within the scan region.

32. The method of claim 28, further comprising determining a gesture of a user in a region above the working surface by an optical scanning device.

33. The method of claim 28, wherein the first image projected by the projector comprises a representation of the second image.

34. The method of claim 33, further comprising arranging the representation of the second image outside a scan region of the camera.

35. The method of claim 28, further comprising illuminating with the projector the object with light of a predetermined spectrum.

36. The method of claim 35, wherein the projector illuminates different segments of the object with different predetermined spectra.

37. The method of claim 28, further comprising with the projector a predetermined background around the object.

38. The method of claim 37, further comprising receiving the predetermined background to be projected via an interface.

39. The method of claim 28, further comprising:
holding a recipe by a data storage unit; and
assigning with a processing facility the second image to a recipe in the data storage unit.

40. The method of claim 28, further comprising supplying the second image to a social network via an interface.
